(19) United States
(12) Patent Application Publication
(10) Pub. No.: US 2009/0065103 A1
(43) Pub. Date: Mar. 12, 2009

(54) METHOD AND APPARATUS FOR IMPROVED FORMABILITY OF GALVANIZED STEEL HAVING HIGH TENSILE STRENGTH

(76) Inventor: Pertti J. Sippola, Espoo (FI)

Correspondence Address: BACON & THOMAS, PLLC, 625 SLATERS LANE, FOURTH FLOOR, ALEXANDRIA, VA, 22314-1176, US

(21) Appl. No.: 12/206,842

(22) Filed: Sep. 9, 2008

Related U.S. Application Data
(60) Provisional application No. 60/967,984, filed on Sep. 10, 2007.

(51) Int. Cl. C23C 2/28; C21D 1/62; B05C 3/12; C22C 38/00

(52) U.S. Cl. 148/533; 266/259; 118/429; 148/320

(57) ABSTRACT

The present invention is directed to a method and apparatus of producing a dual-phase galvanized steel strip with improved formability while maintaining a high tensile strength. The present invention comprises a step of cooling and a step of reheating. In the cooling step, the galvanized steel strip has a temperature reduction of from about 300° C. to about 150° C.-250° C. This step of cooling should cool to a maximum extent of about 150° C. different between the initial temperature and the final temperature. This cooling may be accomplished by a hot water quench, or the use of a cooling tower, or other means. The step of reheating should follow the step of cooling. The step of reheating should heat the galvanized steel strip to a temperature of about 340°-390° C. This reheating causes the martensite in the galvanized steel strip to be tempered at a relatively low temperature, which reduces the Fe—Zn phase formation in the GI-coating.

### BACKGROUND OF THE INVENTION

1. Technical Field

This invention relates to the production of galvanized hot dip dual-phase steels that require high tensile strength while retaining good formability and spot welding requirement properties.

2. Description of Prior Art

In the prior art, dual-phase steels having tensile strength of about 650 MPa and below typically have good manufacturing characteristics including formability and spot welding. As such, their shear factors do not limit design attributes. However, dual-phase steels having tensile strengths greater than about 700 MPa, such 800 MPa referred to as DP800 steel, may not have good manufacturing characteristics.

Industries are therefore interested in so-called TRIP-grade steels having high tensile strength with good formability which typically need a higher carbon content, such as greater than about 0.15%, in order to produce sufficient amounts of retained austenite. The carbon content of retained austenite is typically greater than about 1.2% to be stable at room temperature. This high carbon content of steel alloy, however, made it impossible to achieve proper spot welding requirements to meet industry standards. The goal of producing a dual-phase steel having a tensile strength of 800 MPa with formability and weldability characteristics close to a DP600 rated steel has been heretofore illusive.

Additional prior art limiting factors of a dual-phase steel of 800 MPa include reduced bending properties requiring higher bending radius, and a hole expanding ratio that is reduced due to the local hard Martensite Islands formation.

There are design limitations due to the shear factor of the steel sheet. It has been noted that the critical R/T for DP800=8 and for DP600=4 in order for some designs to be formed successfully. Therefore smaller R/T values of DP800 will benefit the manufacturing design capabilities and reduce material gauging with weight saving opportunities and associated cost reduction. The production of the lean-alloyed (spot weldable), formable DP800 grade steels using different alloyed steel chemistries in a hot dip galvanized line with direct air cooling after zinc bath temperature to ambient room temperature will be impossible with the forming requirements due to the hard Martensite phase formed during such traditional cooling configuration.

Prior art literature has established that a softer Martensite produced during aging/tempering at approximately 300° C. will improve bending and hole expanding properties in a dual-phase steel. Tempering, therefore, of material of Martensite established in continuous annealing lines has good bending properties even at 85% of soft martensite in a DP980 steel as opposed to a DP980 having hard Martensite of approximately 70%.

Literature also notes (K. R. Kinsman et al.) presented in 1967 that thermal stabilization of austenite via dislocation pinning of austenite would produce more retained austenite. In the presence of freshly formed Martensite, the chemical potential of carbon is different in Martensite, austenite and in the interface boundary by virtue of the unrelaxed strain associated with the interface dislocations. During aging/reheating the carbon activity and carbon concentration adjusts towards equilibrium.

Accordingly, when steel strip is rapidly cooled from 300° C. to approximately 250° C. which will be close to M50 temperature (approximately 50% austenite will be formed to Martensite). Thereafter, the steel is reheated to the aging temperature of greater than 350° C. During aging, carbon is assumed to segregate to the dislocation interface surrounding the Martensite nucleus sufficient to pin austenite.

B. Cooman and J. Speer have published as earlier as 2006 that quench and partitioning will produce the increased ductility due to the beneficial effect of the interlath austenite, which is ductile and tough constituent. Typically, the steel grades having retained austenite more than 8% are called TRIP steels. The carbon equivalent may be defined by the following equation:

C.E. (carbon equivalent)=C-%+Si-%/30+Mn-%/20+2P-%+4S-%

Due to spot welding requirements C.E. <0.25% the carbon content of steel substrate for DP800 should be low; max. 0.10%. This will mean that Mn-eq values are very high >2.7% for conventional thermal cycle shown in FIG. 4. Therefore it is difficult to achieve a good coating with such a high Mn %. The amount of Mn-alloying can be reduced to ˜2.2% by adding 0.2% Mo per the formula;

Mn-eq=Mn-%+Cr-%+2.6Mo-%

Using the new galvanizing technologies the coatability problems of conventional technology are significantly eliminated and quenching will additionally eliminate the need of 0.2% Mo alloying shown in FIG. 4.

### SUMMARY OF THE INVENTION

The present invention is directed to a method and apparatus of producing a dual-phase galvanized steel strip with improved formability while maintaining a high tensile strength. The improved properties are achieved by utilizing increased holding temperatures and times between multiple reheating stations in an improved cooling tower configuration and method after the zinc pot of the hot dip galvanizing strip line. The present invention comprises an additional step of cooling and an additional step of reheating, as compared to the prior art. In the cooling step, the galvanized steel strip has a temperature reduction of from about 300° C. to about 150° C.-250° C. This step of cooling should cool to a maximum extent of about 150° C. different between the initial temperature and the final temperature. This cooling may be accomplished by a water quench, or the use of a cooling tower, or other means. The step of reheating should follow the step of cooling. The step of reheating should heat the galvanized steel strip to a temperature of about 340°-390° C. This reheating causes the martensite in the galvanized steel strip to be tempered at a relatively low temperature, which reduces the Fe—Zn phase formation in the GI-coating.

### DESCRIPTION OF THE DRAWINGS

FIG. 1 is a graphic flow schematic line configuration of a steel strip tempering and partitioning in a modified APC cooling tower for hot dip galvanized dual-phase steel to produce the enhanced forming properties.

FIG. 2 is a graphic flow schematic line configuration of a prior art cooling tower used in steel strip hot dip galvanizing process.

FIG. 3 is a time line to temperature graphic illustration of a DP800/1000-GI “soft Martensite” of the invention.

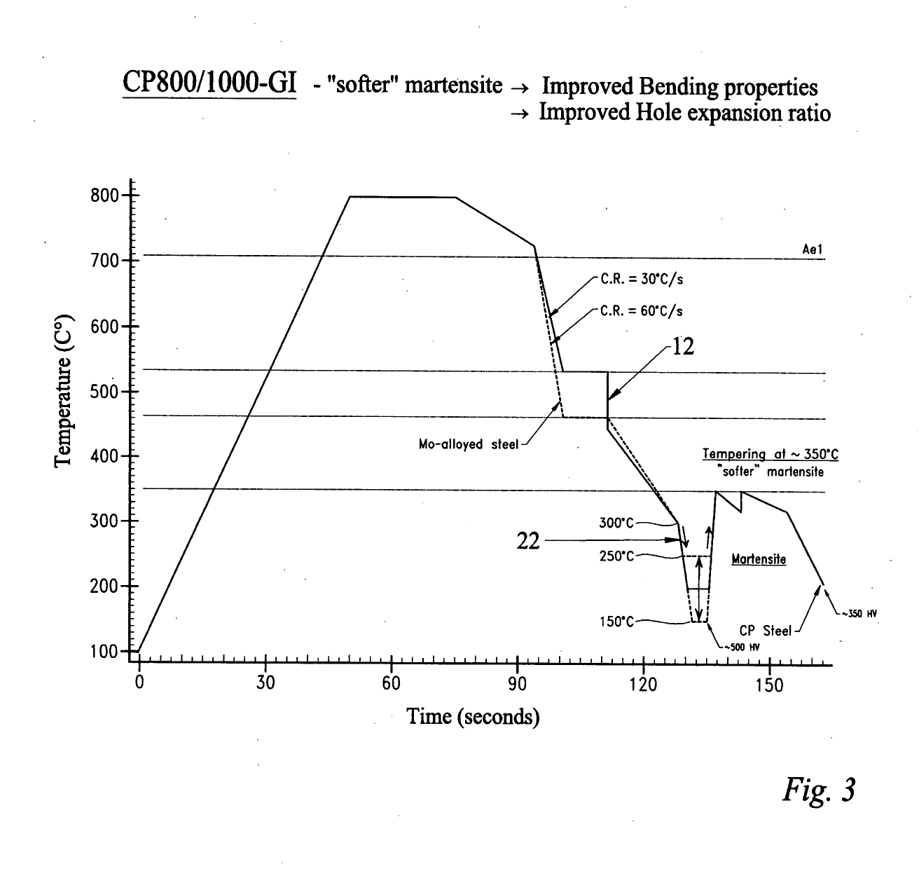

FIG. 4 is a time line to temperature graph illustrating a prior art control of dual-phase thermal cycle for “hard Martensite”.

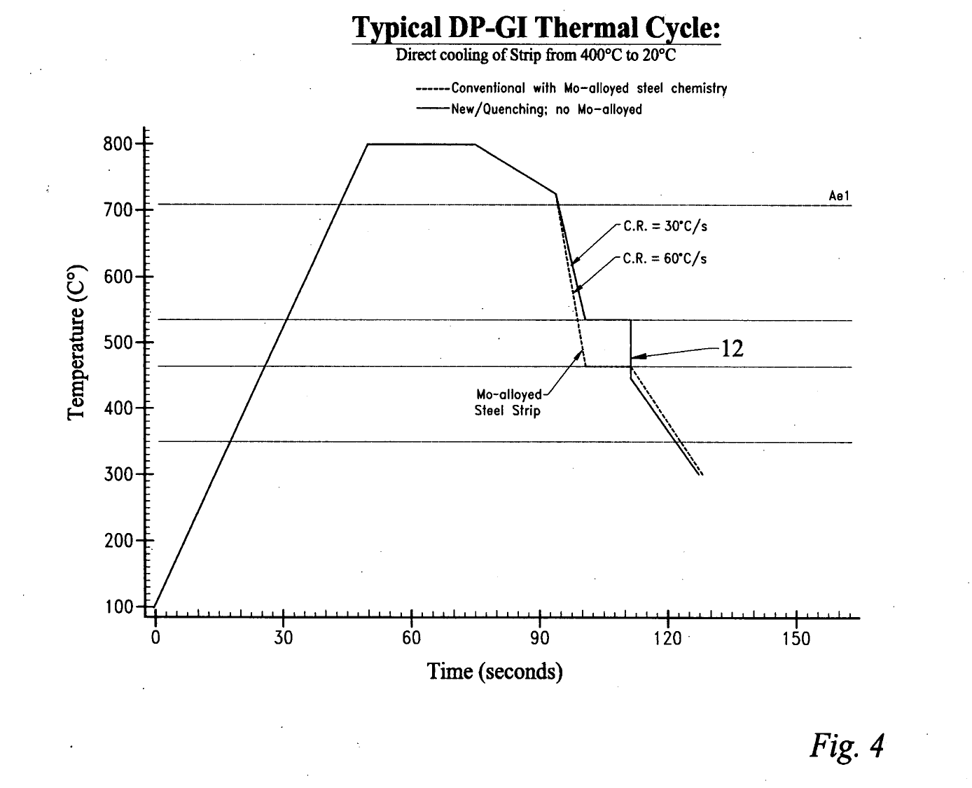

FIG. 5 is a time line to temperature graph illustrating TRIP aided DP800 GI of the invention example.

FIG. 6 is a graph of Martensite hardness versus the different tempering temperatures in Centigrade.

### DETAILED DESCRIPTION OF THE INVENTION

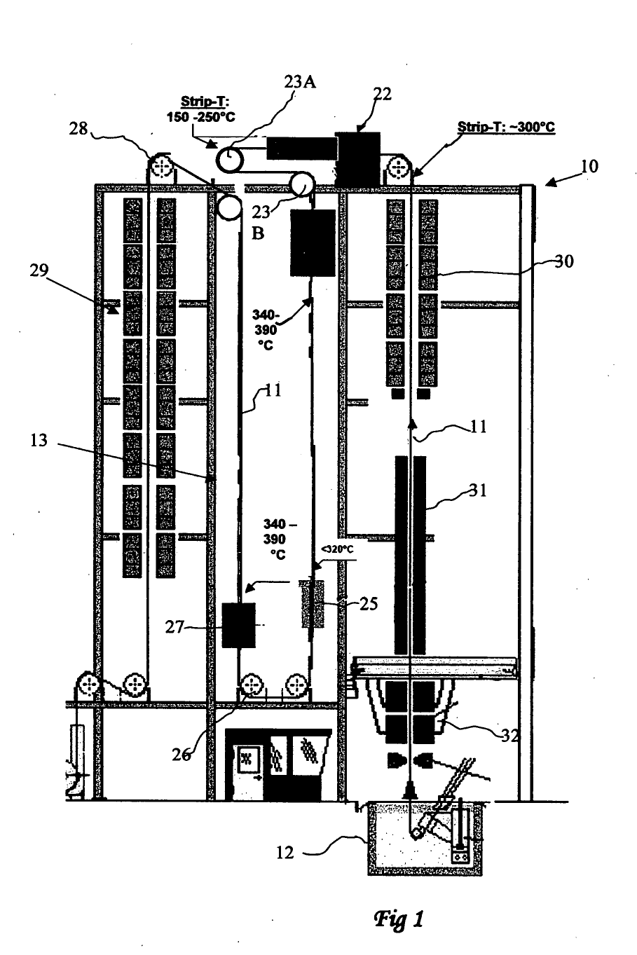

Referring now to FIG. 1 of the drawings, an improved cooling tower 10 configuration and associated method of the invention can be seen to provide tempering and partitioning of a hot-dip galvanized dual-phase steel strip after it leaves the zinc pot 12. The cooling tower 10 is of sufficient height to induce the required treatment and holding times necessary to the method of the invention as disclosed hereinafter. The cooling tower 10 configuration provides for the addition of transfer treatment loop 13. Gas jet coolers 29 and 30, soaking section 31, and induction heaters 32, are each known to the art.

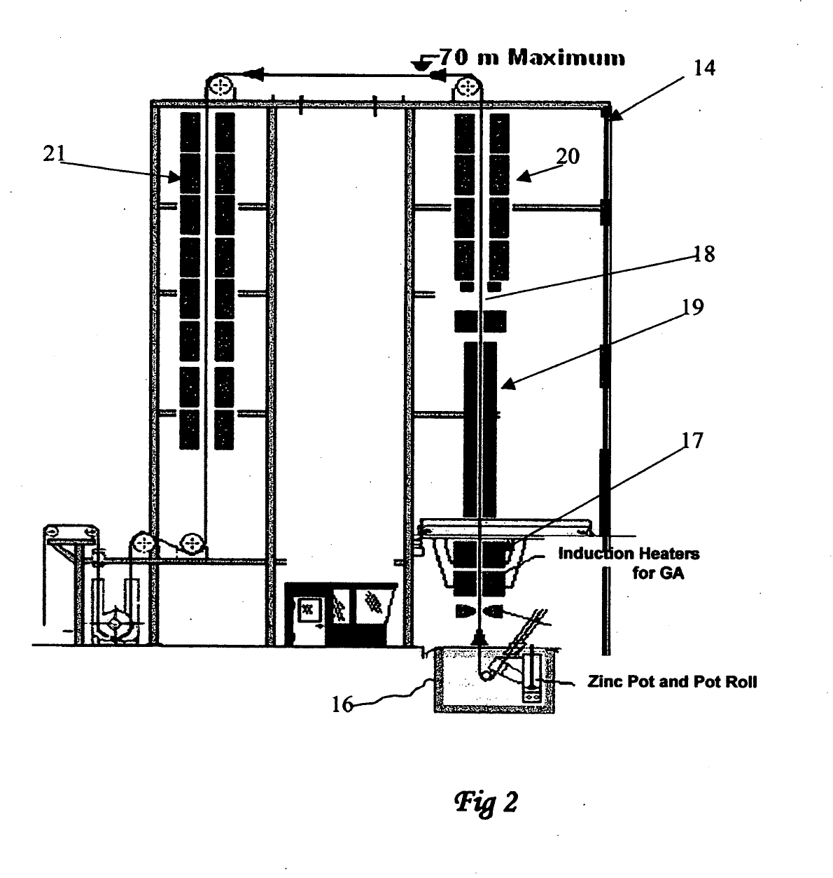

FIG. 2 discloses the traditional single cooling loop of the prior art. The traditional cooling tower 14 can only provide for continuous air cooling after the zinc pot 16. The sole induction heater 17 is used for GA-coated products, not for GI-coated products. As such the galvanized steel strip 18 would then pass through a soaking section 19 of GA, not used for GI, and gas jet cooling station 20 on the first pass of the single cooling loop. On the return pass, a second set of gas jet coolers 21 is provided as is well known and understood to those skilled in the art.

FIG. 1, in contrast, discloses a cooling tower 10 according to the invention, which includes the additional treatment loop 13 that allows for two additional treatment passes. A hot water quench 22 with return rollers 23A and 23B is at the beginning of the loop's first pass. The galvanized steel strip 11 enters the water quench 22 at approximately less than 300° C. and exits after quenching at 150° C. to 250° C. with the maximum cooling of 150° C. In the alternative, if the height of the cooling tower is more than 50 meters then this hot water quench can be avoided or eliminated.

FIG. 1 also discloses a first induction reheater 24, for heating the galvanized steel strip 11 to 340° C.-390° C. In the production of soft martensite dual-phase steels then all austenite is fully transferred to the martensite by the hot water quenching 22 or by cooling of the high cooling tower at a temperature which is below Mf-temperature. Therefore by reheating the galvanized strip 11 as shown, the martensite of the galvanized strip will be tempered at such a low temperature which will minimize Fe—Zn phase formation in the GI-coating due to the induction heating of the steel not the coating.

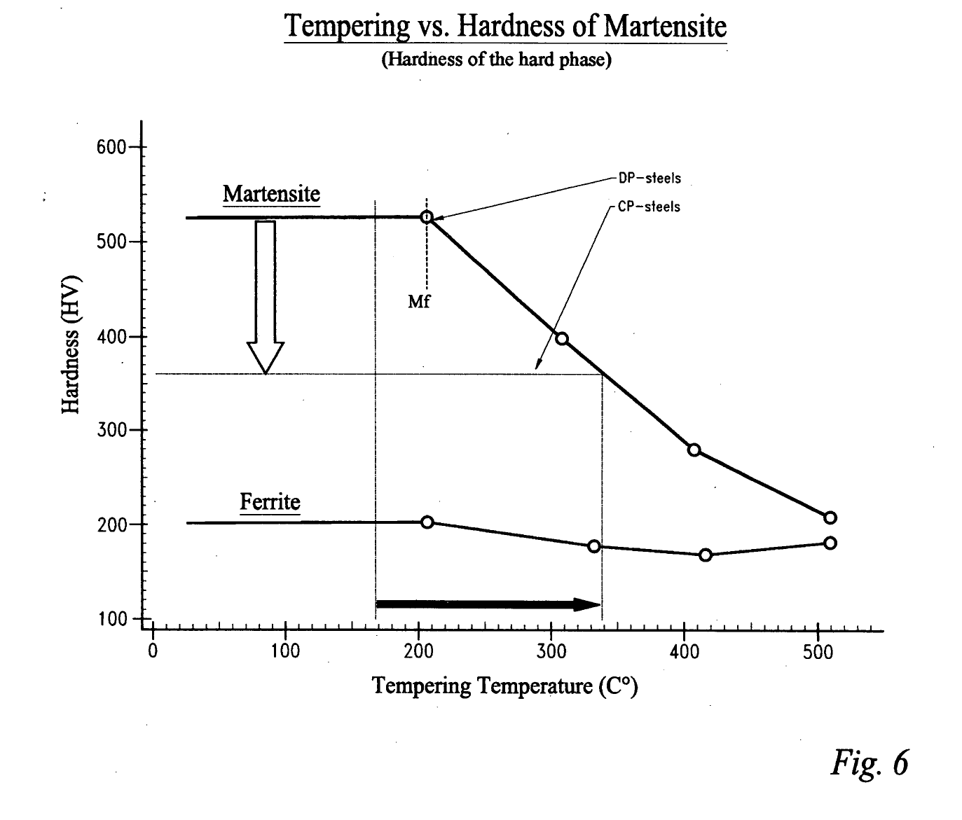

FIG. 6 discloses the tempering versus hardness of martensite relationship which shows the reduction of martensite hardness from higher than 500 HV to less than 350 HV based on temperature indicated by the treatment arrows, as desired by controlling temperature.

The invention also provides for an optional cooling station 25 which can be used in which an air/water mist is employed in certain applications cooling the galvanized steel strip 11 from less than 320° C. to less than 200° C. just before a set of return rollers 26 at the bottom of the treatment loop 13. A second induction heating station 27 is provided at the beginning of the second pass return heating the galvanized strip 11 to 340° C.-390° C. as needed. The return second pass of the treatment loop 13 provides additional time for air cooling the galvanized steel strip 11 before the third set of return rollers 28 at the top of the cooling tower loops and directs the steel strip 11 through a set of conventional gasjet coolers 29 for further temperature reduction and finalized coiling at 30.

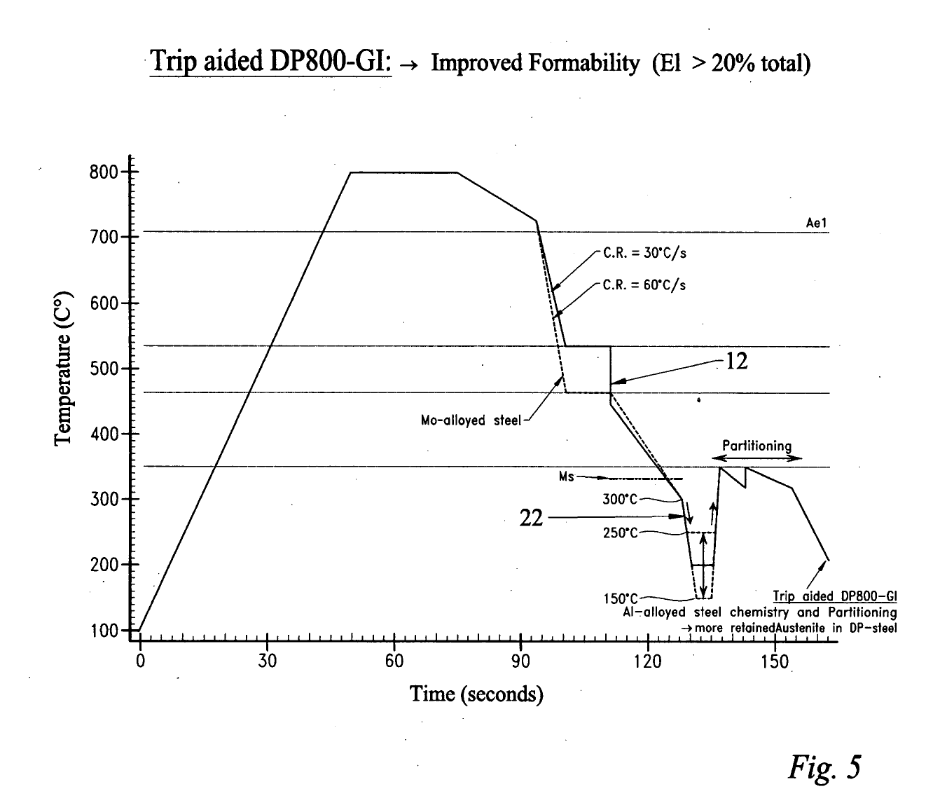

Referring now to FIG. 5 of the drawings, the production of so-called TRIP aided dual-phase steels can be seen wherein heat treatment after the zinc pot 12 needs to cool the steel strip S to approximately 250° C. (less than M50) and then reheat to less than 380° C. for partitioning. During partitioning indicated by time arrow carbon will diffuse from Martensite nucleus to austenite to pin (stabilize) it producing retained austenite. It will be noted, however, that the carbon equivalent of spot weldable dual-phase steels should be low (less than 0.25%) with this C.E.-amount the retained austenite may be from 4% to 8% which will support defining these steel grades TRIP-aided DP800 not TRIP steels.

It will thus be seen that under the improvement of the invention that the addition of a transfer treatment loop 13 (different from a conventional cooling tower 14 configuration) allows for additional multiple treatment of the hot-dip galvanized steel strip 11 versus the traditional paths of the single loop currently available in prior art. It will be seen that the addition of the hot water quench at 22 the beginning of the first pass of the treatment loop 13 and subsequent first reheating by the induction reheaters 24 and time to optional air/water mist cooling at 25 in the first pass and second reheating by induction heating station 27 on the second pass will induce the desired formability attributes of a DP600 grade steel to a desirable high tensile strength grade DP800 grade steel aiding the formability and welding requirements desired in industry.

It will thus be seen that a new and novel cooling tower and method of treatment of dual-phase steel has been illustrated and described and it will be apparent to those skilled in the art that various changes and modification may be made therein without departing from the spirit of the invention.

I claim:

1. A process of making a galvanized steel strip comprising the steps of
(1) a dipping of a steel strip in a zinc pot, and thereafter,
(2) a first cooling of said strip to a temperature of from about 250° C. to about 400° C., and thereafter,
(3) a second cooling of said strip to a temperature of from about 150° C. to about 250° C., and thereafter,
(4) a first reheating of said strip to a temperature of from about 340° C. to about 390° C.

2. The process of claim 1, wherein said second cooling comprises a hot water quench of said strip.

3. The process of claim 1, wherein said second cooling comprises the passing of said strip through a cooling tower of more than 50 meters.

4. The process of claim 1, wherein said first cooling cools said strip to a temperature of approximately less that 300° C., and said second cooling cools said strip to a temperature of about 150° C.

5. The process of claim 1, further comprising
(5) a third cooling after said first reheating, wherein said third cooling cools said strip to a temperature of from about less than 320° C. to about less than 200° C., and thereafter,
(6) a second reheating of said strip to a temperature of from about 340° C. to about 390° C.,
and wherein said first reheating is to a temperature of less than about 380° C.

6. A process of making a galvanized steel strip comprising the steps of
(1) dipping a steel strip in a zinc pot, and thereafter,
(2) cooling said strip to a temperature which is below the Mf-temperature, and thereafter,
(3) heating said strip to be tempered at a temperature to minimize Fe—Zn formation.

7. The process of claim 6, wherein said tempering reduces a martensite hardness to less than 500 HV.

8. The process of claim 7, wherein said tempering reduces a martensite hardness to less than 350 HV.

9. The process of claim 6, wherein said tempering is at temperature of from about 160° C. to about 330° C.

10. The process of claim 7, wherein said tempering is at temperature of from about 160° C. to about 330° C.

11. An apparatus for making a galvanized steel strip comprising
(1) a zinc pot that is adapted to process a steel strip, and downstream therefrom,
(2) a first cooler that is adapted to cool said strip to a temperature of from about 300° C. to about 400° C., and downstream therefrom,
(3) a second cooler that is adapted to cool said strip to a temperature of from about 150° C. to about 250° C., and downstream therefrom,
(4) a first reheater that is adapted to reheat said strip to a temperature of from about 340° C. to about 390° C.

12. The apparatus of claim 11, wherein said second cooler comprises a hot water quench apparatus.

13. The apparatus of claim 11, wherein said second cooler comprises a cooling tower of more than 50 meters.

14. The apparatus of claim 11, wherein said first cooler is adapted to cool said strip to a temperature of approximately less that 300° C., and said second cooler is adapted to cool said strip to a temperature about 150° C.

15. The apparatus of claim 11, further comprising
(5) a third cooler that is downstream of said first reheater, wherein said third cooler is adapted to cool said strip to a temperature of from about less than 320° C. to about less than 200° C., and downstream therefrom,
(6) a second reheater that is a adapted to heat said strip to a temperature of from about 340° C. to about 390° C.,
and wherein said first reheater is adapted to heat said strip to a temperature of less than about 380° C.

16. A galvanized steel strip comprising a TRIP-aided steel with a carbon equivalent of less than about 0.25% and a retained austentite of from about 4% to about 8%.

17. The galvanized steel strip of claim 16, wherein said strip does not comprise Mo.

18. A galvanized steel strip comprising a dual-phase steel wherein said strip does not comprise austentite.
